(19) United States
(12) Patent Application Publication
(10) Pub. No.: US 2010/0323601 A1
(43) Pub. Date: Dec. 23, 2010

(54) AIR CONDITIONING SYSTEM FOR AIRCRAFT CABINS

(75) Inventors: Joerg Cremers, Hamberg (DE); Henrik Derlien, Hamburg (DE); Klaus-Dieter Kricke, Pinneberg (DE); Katja_Maria Wilke, Hamburg (DE)

Correspondence Address: GOODMAN, ALLEN & FILETTI PLLC, 4501 HIGHWOODS PARKWAY, SUITE 210, GLEN ALLEN, VA, 23060, US

(73) Assignee: AIRBUS OPERATIONS GMBH

(21) Appl. No.: 12/667,737

(22) PCT Filed: Jul. 8, 2008
(86) PCT No.: PCT/EP2008/005564

§ 371 Date: May 27, 2010

Related U.S. Application Data
(60) Provisional application No. 60/949,007, filed on Jul. 11, 2007.

(30) Foreign Application Priority Data
Jul. 11, 2007 (DE) 10 2007 032 306.0

(51) Int. Cl. B64D 13/02; B60H 1/22

(52) U.S. Cl. 454/76; 454/160

(57) ABSTRACT

The present invention relates to an air conditioning system (10) for an aircraft cabin (12) with at least one air inlet (14) for supplying air to the cabin (12), at least one air outlet (16) for discharging air from the cabin (12) and at least one compressed-air source (52, 54, 56), which is adapted to provide pressurised fresh air for supplying to the cabin (12) via the at least one air inlet (14). The air conditioning system (10) further comprises a heat exchanger (42) supplied with ram air from a ram air inlet (92) for cooling air from the compressed-air source (52, 54, 56), wherein the heat exchanger (42) is disposed upstream of the air inlet (14) of the cabin (12). It is intended that the air conditioning system (10) comprises a cabin air heat exchanger (100) which is designed to be supplied with air discharged from the cabin (12), wherein the cabin air heat exchanger (100) is disposed downstream of the at least one air outlet (16) and upstream of a point (N) at which fresh air is mixed with air from the cabin (12).

The present invention relates to an air conditioning system for an aircraft cabin with at least one air inlet for supplying air to the cabin and at least one air outlet for discharging cabin air.

On account of the low external temperatures and the low external pressure at high altitudes, air conditioning systems are an indispensable component of modern commercial aircraft. Only through the employment of systems of this kind is it possible to transport passengers with commercial aircraft over long distances while saving fuel.

In most cases air conditioning systems are nowadays supplied during flight with bleed air taken from the hot air stream of engines. The bleed air is as a rule branched off at one of two different points at the engine, namely an intermediate pressure port, IP, and a high pressure port, HP, depending on the flight situation. The use of bleed air is advantageous for air conditioning, as air which is under high pressure and very hot (as a rule at approximately 400° C. and 2 bar) can be regulated to desired temperatures and pressures (the pressure in the cabin is normally approximately 0.8 bar at approximately 20° C.) without having to apply considerable additional quantities of energy. In this respect bleed air can also be used for other consumer systems such as, for example, for systems for de-icing wings (wing ice protection system, WIPS). A further significant advantage when using bleed air lies in the fact that, on account of its high pressure, bleed air can also be routed through relatively long line systems easily. This can be an important argument for using bleed air, in particular for modern large aircraft.

The air of an aircraft cabin is continuously exchanged by supplying the cabin with fresh air (as a rule with a high proportion of bleed air) and removing cabin air which is present. As a rule a significant proportion (typically of the order of magnitude of approximately 50%) of the air which is removed from the cabin is re-used by being admixed with a fresh air stream which is routed to the cabin. The remainder of the cabin air is discharged into the ambient atmosphere.

The publication U.S. Pat. No. 4,419,926 proposes routing the air which is to be removed into the ambient atmosphere via a power recovery turbine, PRT, which utilises the difference in the thermal states of the cabin air and the external air (at a high altitude approximately −55° C. and 0.2 bar) for energy recovery.

In addition to bleed air, aircraft frequently also use so-called ram air, i.e. air which is forced into a ram air inlet through the aircraft movement. This can be used by a compressor in addition to the bleed air as hot, pressurised air, or employed as cooling air without being compressed. Both ram air systems and bleed air systems are as a rule employed during flight.

On the ground the air for the cabin is frequently provided by an auxiliary power unit, APU, which drives a compressor.

The documents CA 2 546 714, DE 102 34 968, WO 99/12810 and U.S. Pat. No. 4,684,081 describe air conditioning systems for aircraft cabins in which different arrangements of ram air compressors, bleed air sources and APUs are used for supplying fresh air to an aircraft cabin. Documents US 2007/0113579 A1 and U.S. Pat. No. 5,442,905 also relate to air conditioning systems for aircraft cabins.

Modern aircraft engines have a tendency to relatively high bypass ratios, BPR, of the air streams in the engine, whereby bleed air taken from the engine core has a particularly negative effect on the fuel consumption of the aircraft. Moreover, the bleed air which is intended for use in the cabin has to be cooled in a plurality of steps in order to bring it into a thermal state which is acceptable for supplying it to the cabin. Energy losses inevitably occur in the process, as thermal energy of the bleed air is lost through cooling.

A general rule is to make the air conditioning system for an aircraft cabin as efficient and light as possible in order to reduce the fuel consumption. A reduced fuel consumption can also generally be achieved by reducing the weight of the aircraft.

There is therefore a need in the field of air conditioning systems for aircraft cabins for particularly efficient systems which exhibit a favourable energy balance and reduce the fuel consumption of the aircraft.

### SUMMARY OF THE INVENTION

In order to achieve this object, the invention provides an air conditioning system for an aircraft cabin according to claim 1. The air conditioning system comprises at least one air inlet for supplying air to the cabin, at least one air outlet for discharging air from the cabin, at least one compressed-air source, which is adapted to provide pressurised fresh air for supplying to the cabin via the at least one air inlet, and a heat exchanger supplied with ram air from a ram air inlet for cooling air from the at least one compressed-air source. The heat exchanger is disposed upstream of the air inlet of the cabin. The air conditioning system according to the invention also comprises a cabin air heat exchanger which is designed to be supplied with air discharged from the cabin via the at least one air outlet and intended to be supplied to the cabin again (so-called recirculation air). The cabin air heat exchanger is disposed downstream of the at least one air outlet and upstream of a point at which fresh air from the at least one pressure source is mixed with air from the cabin intended to be supplied to the cabin again.

This system according to the invention enables a recycled air stream from the cabin to be treated by the cabin air heat exchanger separately from a fresh air stream from the compressed-air source. This enables the temperature of the individual streams and therefore also the temperature of a merged stream to be controlled more precisely. In particular, air stream cooling can take place very accurately according to the requirements of the flight situation. It is, moreover, possible to use heat exchangers with small dimensions instead of one heat exchanger with large dimensions. These small heat exchangers afford a considerable amount of freedom in the design of the aircraft and entail advantages in relation to the weight distribution in the aircraft. At the same time the system has redundancy, for in the event of failure of the heat exchanger for fresh air some of its functions can easily be transferred to the cabin air heat exchanger.

It is advantageous to design the cabin air heat exchanger for cooling air discharged from the cabin as for being supplied with ram air from a ram air inlet as well. Cool air can as a result be supplied to the cabin air heat exchanger in a simple and energy-efficient manner, so that the cabin air can be cooled to a desired temperature.

In one embodiment of the invention the heat exchanger for cooling fresh air is disposed upstream of said mixing point. This results in complete separation of heat exchange of the recirculated cabin air stream and the fresh air stream and enables the heat exchangers to be of a particularly small construction.

It is possible to dispose at the mixing point a mixing device in which the fresh air stream and the cabin air stream are merged. This facilitates controlled merging of the air streams, in particular when the thermal states of the streams exhibit relatively large differences.

Downstream of the mixing point and upstream of the at least one cabin air inlet there is provided a mixing device which is designed to mix bleed air from a bleed air source with air flowing in via the mixing point. The direct supply of bleed air to the mixing device affords a simple and efficient possibility of heating the air stream, if desired, before it is supplied to the cabin.

In a preferred embodiment the air conditioning system comprises, as compressed air-sources, a bleed air source, a source of compressed ram air and a source of air compressed by an auxiliary power unit. This combination of sources allows the air conditioning system to be supplied with fresh air in a highly flexible manner, depending on the flight situation.

According to a further aspect of the invention, which can be employed by itself or combined with the above-mentioned aspect, an air conditioning system for an aircraft cabin is provided which comprises at least one air inlet for supplying air to the cabin and at least one air outlet for discharging cabin air, wherein the air conditioning system also comprises downstream of the at least one air outlet of the cabin a power recovery device for recovering energy from discharged cabin air. This aspect of the invention also comprises the arrangement of a heating device, which is coupled to an external heat reservoir, for heating air discharged from the cabin downstream of the cabin. In this connection external means that the heat reservoir in question is not connected to one of the air inlets or air outlets of the air conditioning system to route air. The heating device can preferably be disposed upstream of the power recovery device.

By using a heating device of this kind the cabin exhaust air can be heated before being supplied to the power recovery device, so that the power recovery device can be operated particularly efficiently. At the same time the problem of the increased number of heat sources (e.g. electronic systems) distributed in modern aircraft, which is connected, inter alia, with increasing electrification, can be reduced by using the waste heat of systems of this kind to heat the cabin air supplied to the power recovery device and therefore to increase the efficiency of the air conditioning system.

It is in this respect of advantage to dispose a heat exchanger upstream of the heating device with external heat reservoir and downstream of the air outlet. Such a heat exchanger disposed between the cabin and the heating device effects additional preheating of the discharged cabin air, which leads to a further increase in the energy recovered by the power recovery device.

This heat exchanger can be designed for heat exchange between air discharged from the cabin and fresh air coming from one or a plurality of compressed-air source(s). In this way hot fresh air can be cooled and at the same time the heat taken from it can is be used to increase the efficiency of the power recovery device.

In a particularly preferred embodiment the at least one external heat reservoir comprises machine oil. This machine oil represents one of the hottest heat sources on board an aircraft and can therefore be used particularly well as an external heat source. Due to the reduction in the oil temperature linked with this, the lubricating efficacy of the machine oil is increased at the same time.

Moreover, in one embodiment an auxiliary power unit may be provided. In this respect it is of particular advantage to design the power recovery device for driving the auxiliary power unit. The energy recovered by the power recovery device can thus be used directly for operating the aircraft. In particular in modern aircraft, the auxiliary power unit (APU) is frequently employed for support during flight or, in the event of an engine failing, takes over a part of supplying energy or compressed air. When employing the APU, by supplying the power from the power recovery device, it is possible to avoid overload of other energy sources.

Alternatively, it is possible for the air conditioning system also to comprise a motor coupled to a ram air compressor, the power recovery device being coupled to the motor and the ram air compressor such that, in an operating mode in which the power recovery device is driven by discharged cabin air, the power recovery device can drive the motor with a generator function and the ram air compressor. An arrangement of this kind enables the ram air which is to be supplied to the air conditioning system as fresh air to be provided without requiring a further energy supply, and at the same time electricity to be made available for aircraft systems, for example for a control device of the air conditioning system or other devices, through the motor, which is used as a generator.

In one preferred embodiment the power recovery device is embodied as a turbine. This affords an efficient and robust possibility of taking energy from the air stream.

According to a further aspect of the present invention, which can be employed by itself or together with one or a plurality of the above-mentioned aspects, an air conditioning system for an aircraft cabin is provided which comprises at least one air inlet for supplying air to the cabin and at least one air outlet for discharging cabin air. At least one water separator is disposed downstream of the air outlet of the cabin. The water separator is provided for the through-flow of air which is to be discharged into the ambient atmosphere of the aircraft. The water separator is designed to separate water from the air from the cabin flowing through it and retain this in the aircraft. The recovered water can then be used, for example, to humidify cabin air, as service water for sanitary systems and similar purposes. As a result, the water quantity to be carried when the aircraft takes off is reduced, which entails a corresponding saving in take-off weight. The saving in take-off weight and the corresponding fuel saving and/or payload increase can be considerable, in particular in the case of modern large aircraft with a large cabin volume and several hundred passengers.

It is particularly advantageous to provide at least one power recovery device disposed downstream of the air outlet of the cabin. This can be embodied as described above and also employed in one of the configurations described above. The combination of the power recovery device and the water separator downstream of the cabin permits maximum utilisation of the energy and the water content of the discharged cabin air.

In a preferred embodiment of the invention the at least one water separator is disposed downstream of the at least one power recovery device. In this configuration the water separated from the cabin air after the power recovery device has cooled and slowed down the air through energy recovery. The air is therefore preferably at a temperature near freezing point in the water separator, so that water in the air can condensate out almost completely, which facilitates separation of almost the entire water content.

In an alternative embodiment the at least one water separator is disposed upstream of the at least one power recovery device. For it may be advantageous to separate water from the air before it flows into the power recovery device. It is thus possible to prevent the power recovery device from icing up through condensing water, which could otherwise be cooled to below 0° C. through the removal of energy and freeze.

In a preferred embodiment of the invention at least one water separator is to be disposed upstream of the cabin and at least one water separator is to be disposed downstream of the cabin. The first water separator is intended for separating water from the air to be supplied to the cabin in order to prevent parts of the air conditioning system from freezing in one of the usual several cooling steps due to water contained in the air. The water balance of the air conditioning system according to the present invention can largely be adjusted and controlled through the combination of two water separators as described.

According to a further aspect of the invention, which can be employed by itself or in combination with the above-mentioned aspect, there is provided an air conditioning system for an aircraft cabin which comprises at least one air inlet for supplying air to the cabin and at least one air outlet for discharging cabin air. The air conditioning system also comprises at least one source of compressed air for providing pressurised fresh air to the cabin via the at least one inlet. For cooling purposes, the at least one source of compressed air is connected to a fresh air cooling system, which preferably is adapted to use ram air to cool a stream of fresh air provided by the at least one source of compressed air. The air conditioning system also comprises a cooling device which is adapted to be independent of ram air to provide cooling and may be arranged to be separate from the compressed air cooling system. Thus, the cooling device is not connected with a ram air source that provides cool ram air to be used for cooling an air stream to be provided to the cabin. Preferably, the cooling device is adapted to be driven electrically. This provides a cooling device which can be operated separately and independently from the usual air conditioning system components. Thus, the flexibility and redundancy of the air conditioning system is increased. In particular, while the aircraft is on ground, with rather warm air surrounding it and no cool ram air available from the surroundings, it is usually highly inefficient to use a common aircraft air conditioning system and the separate cooling device can be used much more efficiently under such circumstances. The cooling device may be a cooling device adapted to utilize a phase change of a medium, in particular it may be an evaporative cooling device.

In particular, the cooling device may be connected to cool an air stream coming from the ambient atmosphere. This enables the cooling of air when the aircraft is on ground. Alternatively or additionally, the cooling device may be connected to cool an air stream from the source of fresh air or from several sources of fresh air. Thus, the cooling device provides a further possibility to cool fresh air. The cooling device may be adapted to cool recirculated air from the cabin as well, either only recirculated air alone or in an air stream comprising both recirculated air and fresh air from one or more sources of fresh air.

Preferably, the cooling device can be used selectively to cool the air stream. For that purpose, there may be provided a bypass valve. This bypass valve may be controlled to guide an air stream into the cooling device, or to guide the airstream to be cooled directly to the compressed air cooling system. In the latter case, it is advantageous if the compressed air cooling system comprises one or more heat exchangers, which can be arranged as described above regarding the other aspects of the invention.

The air conditioning system may also be adapted such that the either only the cooling device, only the compressed air cooling system or both in a combination may be used to cool an air stream.

In a preferable embodiment, the cooling device is provided or connected to a water separator to extract water from the air stream directed through the cooling device. This allows to prevent air with undesired high humidity from being provided to the cabin. Thereby, a comfortable environment may be provided to passengers in the cabin, in particular in very hot countries with a high level of humidity in the air when the aircraft is grounded.

It is advantageous if the compressed air cooling system is provided with a heat exchanger connected to the at least one air inlet of the cabin. Preferably, an air stream may be guided from the cooling device to the heat exchanger. Thus, the heat exchanger of the compressed air cooling system and the cooling device may be used in combination. The heat exchanger of the compressed air cooling system may be provided with ram air to cool an airstream to be guided to the cabin. Thereby, in particular during flights at high altitudes, cold ram air from the ambient atmosphere of the aircraft may be used efficiently.

According to a further aspect, the present invention also comprises an aircraft with an air conditioning system according to one of the variants of the invention which are described above.

### BRIEF DESCRIPTION OF THE FIGURES

FIG. 1 shows one embodiment of an air conditioning system according to the invention.

FIG. 2 shows a further embodiment of an air conditioning system according to the invention.

### DETAILED DESCRIPTION OF THE EMBODIMENTS

In the following figures conducts for air streams are represented by solid lines without the lines having been provided with their own reference numbers in order to maintain the clarity of the figures. Lines for electric current have not been represented, likewise for reasons of clarity. It is directly obvious to the person skilled in the art from the drawings and the associated description where lines for electrical power supply and electrical signals are to be disposed. Moreover, as regards the mixing devices or mixers mentioned in this description, these are adapted to merge a plurality of air streams, in particular those which have different thermal and dynamic states. Of course a mixer can also serve as a branching and distributing device for one or a plurality of air stream(s), depending on the flow conditions. It also should be noted that most of the components described here are provided in an aircraft at least in duplicate to provide redundancy. Also, in an aircraft there are usually at least two engines providing bleed air, in many cases four or even more engines. To increase the comprehensibility of the description and the figures, these have been omitted.

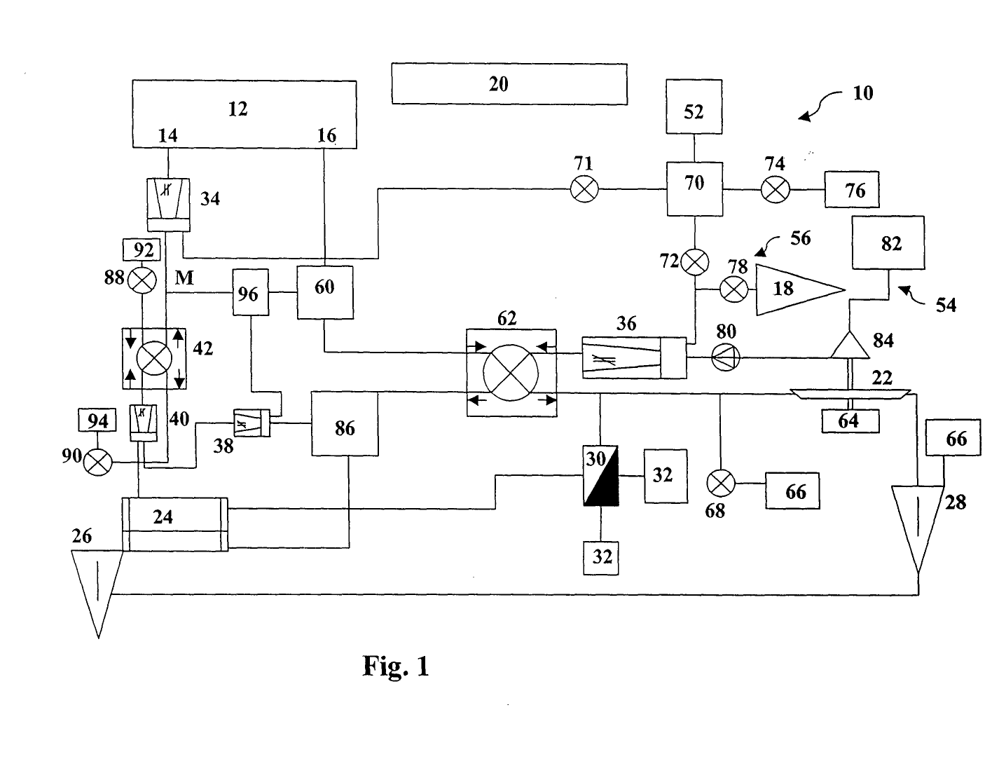

An air conditioning system (Environmental Control System, ECS) 10 according to a preferred embodiment of the present invention is represented in FIG. 1. An aircraft cabin 12 comprises an air inlet 14 and an air outlet 16. It is of course alternatively also possible for the cabin 12 to comprise a plurality of air inlets 14 and/or air outlets 16. The air inlet 14 and the air outlet 16 of the cabin 12 are only represented generally, although it is clear to a person skilled in the art that an air distribution system of the cabin 12 can be highly complex. This applies in particular when, as is usual in the case of modern aircraft, the cabin is divided into zones climatised differently.

The air conditioning system comprises a first compressed-air source 52 which provides bleed air from an engine or motor (not shown) of the aircraft. This bleed air is generally at a temperature of approximately 400° C. and a pressure of 2 bar.

The air outlet 16 is connected to an air distributor 60. The air distributor 60 can route air discharged from the cabin 12 for re-use into an inlet air stream to the cabin (recirculated air). Also, discharged air can be routed via the distributor 60 to a cabin heat exchanger 62 (CHX) (waste air).

The cabin heat exchanger 62 is connected via a line to a power recovery device 22. The power recovery device 22 is preferably embodied as a turbine. The power recovery device 22 can be driven by air flowing in from the heat exchanger 62.

In this embodiment the power recovery device 22 is connected to a motor 64. The motor 64 can be used to drive the power recovery device 22; the motor 64 can alternatively also be driven as a generator for generating power by the power recovery device 22 if this is operated by discharged air from the cabin 12.

After discharged cabin air has flowed through the power recovery device 22 and delivered energy to the latter, the air flows to a water separator 28. The water separator 28 is preferably embodied as a cyclone in which the inflowing air is brought into rotation and the air contained therein condenses at side walls of the cyclone. Further known types of water separators are also conceivable. It may alternatively be expedient to dispose the water separator 28 upstream of the power recovery device 22. The air is as a result dried before it enters the power recovery device 22, so that the device 22 is not iced up through water condensing and freezing during energy recovery.

After passing through the water separator 28 and the power recovery device 22, the air discharged from the cabin in this flow branch has lost the major part of its energy and almost its entire water content has been separated from it. An aircraft air outlet 66 is provided to discharge this dry, cold air into the ambient atmosphere of the aircraft.

A bypass valve 68 between the cabin heat exchanger 62 and the power recovery device 22 is provided to route the discharged air directly to an aircraft air outlet 66 when this is desired. This may, for example, be the case if, on account of the external pressure conditions, the operation of the power recovery device 22 is not efficient, for instance if the aircraft is flying very low or is on the ground. Hereby, the air outlet 66 may be identical with that to which the water separator 28 is connected. Another air outlet may alternatively also be provided, depending on the requirements of the aircraft.

Also provided in this embodiment of the present invention is a bleed air source 52 which provides bleed air from an engine. The bleed air source 52 is connected to a bleed air distributor 70 so that air can flow from the bleed air source 52 to the bleed air distributor 70. The bleed air distributor 70 is connected via a line and a valve 71 to a mixing device 34 which is disposed upstream of the cabin 12. Bleed air can as a result be directly used, by admixing, to heat an air stream which is intended to be supplied to the cabin 12 and which flows via the mixer 34 connected to the cabin air inlet 14.

The distributor 70 is also connected via a bleed air valve 72 to a further mixing device 36. A consumer valve 74 is incorporated into a connection from the distributor 70 to further consumers 76, such as, for example, a wing de-icing system, so that consumers 76 of this kind can be supplied with bleed air.

A further compressed-air source 56 is connected via a further valve 78 between the bleed air valve 72 and the mixer 36, which source provides compressed air from an auxiliary power unit 18 (APU) respectively a compressor (not shown) driven by the latter. The valves 68, 71, 72, 74 and 78 are embodied as control valves which can be activated by a control device 20. The valve 78 can of course also be embodied as a non-return valve which only lets air flow in the direction from the auxiliary power unit 18 to the mixer 36 in order to prevent bleed air from flowing into the auxiliary power unit 18.

A further compressed-air source 54 is connected via a non-return valve 80 to the mixing device 36. The non-return valve 80 can be connected for control by the control device 20. A ram air inlet 82 is provided to supply air from the ambient atmosphere of the aircraft to an air compressor 84. The air inlet 82 and the compressor 84 therefore represent the compressed-air source 54, which provides compressed ram air from the ambient atmosphere of the aircraft. In this embodiment the compressor 84 is coupled to the power recovery device 22 and the motor 64. The compressor 84 can as a result be operated by the power recovery device 22 when this is employed to recover energy from discharged cabin air. The compressor 84 can alternatively also be driven by the motor 64 when the power recovery device 22 is not active. This may be the case, for example, at a low altitude, when the temperature and pressure difference between discharged cabin air and external air is not large enough to operate the power recovery device 22 efficiently.

As a whole, the air conditioning system is therefore designed so that air streams can be routed from a bleed air source 52 and/or a ram air source 54 and/or an auxiliary power unit source 56 through the valves 72, 78, which are controlled by the control device 20, and the valve 80 to the mixing device 36. The mixer 36 is connected to the cabin heat exchanger 62, so that air streams which are mixed in the mixer 36 can be passed on to the cabin heat exchanger 62.

Heat can be exchanged between discharged cabin air and fresh air supplied by the compressed-air sources 52, 54, 56 in the cabin heat exchanger 62. It is in particular possible to heat the discharged cabin air, as the air stream from the mixer 36 is as a rule a great deal hotter than the cabin air.

The heat exchanger 62 is also connected on one of its outlet sides to a distributor 86, to which the fresh air from the heat exchanger 62 is routed. The distributor 86 comprises on one hand a connection to a further mixing device 38 and is connected on the other hand to a cooling device 24. The cooling device 24 is preferably embodied as an electrically driven cooling device. Via the distributor 86 an air stream can therefore be routed for cooling to the electric cooling device 24 or pass to the mixing device 38. It is of course also possible to branch off a respective partial stream from the distributor 86 to the cooling device 24 and to the mixer 38.

The electric cooling device 24 is coupled to a water separator 26 which can be embodied similarly to the water separator 28 described above. The water separators 26, 28 preferably fill a common water reservoir (this is indicated in the figure by the connection of the water separators 26 and 28). Water which is separated by the water separators 26, 28 can, for example, be used to humidify cabin air, as service water for toilets or similar. Preceding filtering is of advantage for use as drinking water in order to remove pollutants and impurities.

Furthermore, the cooling device 24 is connected to a heating device 30 in order to transport heat. It is as a result possible to utilise waste heat of the cooling device 24. The heating device 30 is also connected to one or a plurality of external heat reservoir(s), which are generally designated by 32. Hereby all heat reservoirs on board the aircraft which are not normally connected to the air conditioning system, in particular those which are not in fluid connection with one of the air inlets or air outlets of the air conditioning system, can be considered as external heat reservoir 32. It is particularly expedient to provide hot machine oil of the engines as heat reservoir 32. Hot electronic components and any other heat sources in the aircraft are also conceivable as external reservoirs.

The distributor 86 may guide an air stream such that it is guided to bypass the cooling device 24. For this purpose, there may be provided a bypass valve in the distributor 86. Alternatively, a bypass valve may be arranged in the line guiding air to be cooled to the cooling device 24. The cooling device 24 is not dependent on cool ram air to perform cooling. It thus functions separately from components of the compressed air cooling system utilizing a heat exchanger, e.g. heat exchanger 42, provided with ram air and may in particular be used with high efficiency when the aircraft is on the ground or at low altitudes, i.e. when no cool ram air is available. Also, it is possible and even desirable to arrange the cooling device 24 separately from the rest of the components for cooling the air stream, as it does not need to be directly connected to a source of ram air for cooling. Nonetheless, it is adapted to cool an air stream from a source of compressed air like the bleed air source 52 and/or the ram air source 54 and/or the auxiliary power unit source 56. However, it also may be used for cooling air from the ambient atmosphere which may be provided without or without significant compression, e.g. at ground level. The cooling device 24 preferably is adapted to utilize evaporation cooling to cool an airstream guided to pass through it.

The heating device 30 is also connected to the exhaust air line behind the heat exchanger 62, so that air discharged from the cabin 12 can be further heated. As a result, the temperature and pressure difference between the heated cabin air and the external air becomes even greater and the power recovery device 22 can be operated particularly efficiently.

In the system which is shown in FIG. 1 the cooling device 24 is connected to a mixer 40 which in turn has a connection with the mixer 38.

The mixer 40 is also coupled to a heat exchanger 42. The heat exchanger 42 is supplied with cool ram air via a ram air inlet 92, which can, although does not have to, be connected to the above-mentioned inlet 82 of the compressed-air source 54. Following a heat exchange in the heat exchanger 42, the ram air from the ram air inlet 92 is discharged via an air outlet 94 into the ambient atmosphere of the aircraft. This outlet 94 can of course also be independent, or coupled to other outlets (e.g. 66), or even be identical with them. The flow of ram air into and through the heat exchanger 42 can be regulated by a heat exchanger inlet valve 88 and a heat exchanger outlet valve 90, which are disposed between the inlet 92 and the heat exchanger 42 and the heat exchanger 42 and the outlet 94, respectively. The heat exchanger 42 can be considered as component of a sub-system of the air conditioning system provided with ram air to cool an air stream in contrast to the separate cooling device 24 which is not dependent on ram air.

A connection with the mixer 34 is provided on the side of the heat exchanger 42 which is located downstream in respect to the air stream from the mixer 40. There is a connection between this mixer 34 and the mixer 38 via a further distributor 96, which is in addition connected to the distributor 60. It is thus possible to feed cabin air which is to be re-used into the air stream at a mixing point M via the distributor 96 upstream of the mixer 34. At this point the thermal properties of the air stream flowing from the heat exchanger 42 and the cabin air are normally already sufficiently similar, so that no special mixing device is necessary. It is of course alternatively possible to provide such a mixing device at the mixing point M.

The control device 20 is provided to control the air streams as desired by controlling the individual components of the air conditioning system 10. The control unit 20 is represented without control lines, power supply lines, sensors, computing units and other components associated therewith for reasons of clarity. The control device 20 is in particular designed to control the various valves, mixers, distributors, heat exchangers, compressed-air sources, units, heating and cooling devices and other devices of the air conditioning system according to requirements, so that the desired air streams are obtained.

The system which is shown in FIG. 1 enables fresh air from three different compressed-air sources 52, 54, 56 to be fed into the air conditioning system 10 and to be merged in a mixer 36 according to requirements and according to environmental conditions. An air stream which is mixed in this mixer 36 can then be cooled via the cabin heat exchanger 62 and the heat exchanger 42. However the air stream can also be controlled so that it loses heat via the electric cooling device 24, which is particularly appropriate in situations where no cool ram air is available, e.g. on ground level. In addition, bleed air from the bleed air source can be directly routed to the mixer 34 via the valve 71.

Via the distributors 60 and 96 some of the air which is discharged from the cabin can be added to the fresh air and be re-used. It is possible, via the distributor 96, to add air from the cabin to the fresh air stream intended to be supplied to the cabin 12 both downstream of the heat exchanger 42 and upstream of the heat exchanger 42.

The air conditioning system 10 respectively the control device 20 has at least two operating modes. The first operating mode is in particular intended for high altitudes with a low external pressure and low external temperatures. In this first operating mode air from the bleed air source 52 and the source of compressed ram air 54 is used for the air conditioning system 10; air which is compressed by the auxiliary power unit 18 is not required. The fresh air streams are merged in the mixer 36 and cooled in the heat exchanger 62 through interaction with the air discharged from the cabin 12 through the outlet 16. Afterwards the air stream of cooled fresh air is routed via the distributor 86 to the mixer 38, bypassing the cooling device 24. The part of the cabin exhaust air which is to be re-used is likewise routed via the distributors 60 and 96 to the mixer 38, where it is mixed with fresh air. The resultant air stream is routed via the mixer 40 to the heat exchanger 42. The inlet and outlet valves 88 and 90 are set so that this heat exchanger 42 is supplied with cold ram air and cools the air stream from the mixer 40 further. The air stream flows via the mixer 34 through the air inlet 14 into the cabin. Depending on the operating state and the prevailing requirements, it is also possible in this operating mode for air coming from the cabin 12 only to be added to the fresh air stream after this has passed through the heat exchanger 42.

In this operating mode the part of the cabin air intended to be discharged into the ambient atmosphere of the aircraft is routed via the heat exchanger 62 to the power recovery device 22. The discharged air is then further heated in the heat exchanger 62; the heating device 30 also contributes to additional heating. On account of the large difference between the state of the cabin air (approximately 20° C., 0.8 bar before heating in the heat exchanger 62) and that of the external air (approximately −55° C., 0.2 bar at a high altitude), the power recovery device 22 is operated particularly efficiently. As a result, the motor 64 connected thereto can be operated as a generator and the ram air compressor 84 can also be driven by the power recovery device 22. The bypass valve 68 remains closed in this operating mode.

The air stream is slowed down and cooled by delivering power in the power recovery device 22. The major part of its water content is then separated from the air stream in the water separator 28. The temperature of the air in the separator 28 is preferably approximately 0° C., so that the contained water condenses almost completely without freezing. By using a water separator 28 for the cabin air intended for discharge from the aircraft, the water quantity which is to be carried and therefore the take-off weight of the aircraft can be reduced, which leads to energy savings. If the water is completely removed (which is possible at temperatures in the separator 28 of around 0° C. on account of the almost complete condensation), given a typical medium-range aircraft, an air humidity in the cabin 12 of 10-15% and a flight of 7 hours duration, approximately 275 kg of water can be generated by the water separator 28. Some of this water is introduced into the air of the cabin 12 by conventional air humidification equipment of the air conditioning system (not shown) and some comes from breathing and perspiration of the passengers. This water is not lost, as was previously the case, with the system which is represented here, but is instead re-used.

The second operating mode is suitable in particular at low altitudes or on the ground. In this case the auxiliary power unit 18 (the APU) is used to produce compressed air. The compressed air which is thus produced is likewise routed via the heat exchanger 62. The fresh air is routed through the distributor 86 to the cooling device 24 which, operated electrically, cools the air. The cooled air is routed to the mixer 40. According to requirements, air coming from the cabin 12 can be supplied to the fresh air stream via the distributors 60, 96 and the mixers 38, 40 or further downstream, not until the mixing point M. From the mixer 40 the air stream—whether with or without admixed cabin air—is routed to the heat exchanger 42. Hereby it is not normally necessary to set the valves 88 and 90 so that the heat exchanger 42 is supplied with ram air. At high external air temperatures the heat exchanger 42 can however also be used to heat the air which is passed through. The air stream is then routed to the mixer 34, with the possibility of a first-time or further admixture of cabin air taking place at the mixing point M. The air stream is then routed from the mixer 34 to the cabin 12. In the flow branch downstream of the air outlet 16 the bypass valve 68 is opened and the power recovery device 22 and the water separator 28 remain inactive in this operating mode.

The two described operating modes only represent two possible operating modes. The control device 20 is designed to control the air conditioning system 10 according to requirements such that any desired intermediate modes can be adopted. For example, partial streams can be routed via different branches of the system, and/or both the electrical cooling device 24 and the two heat exchangers 62 and 42 can be used in an intermediate mode.

It is in particular possible in the described system, in a particularly simple manner, to bypass or to replace faulty components, which gives the system inherent redundancy.

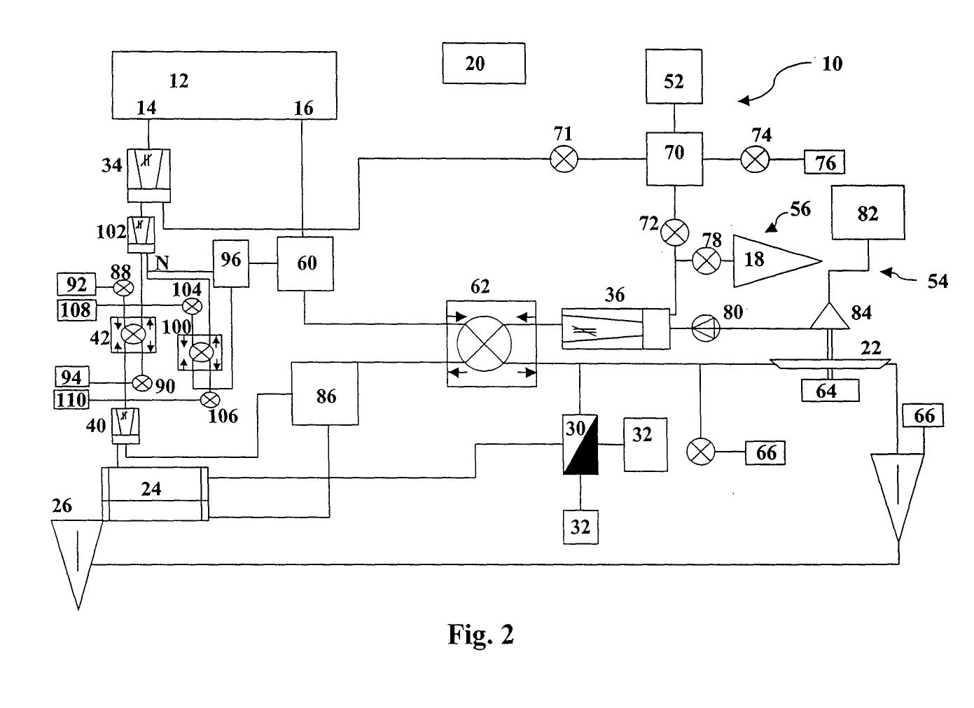

An air conditioning system 10 which is similar to the system represented in FIG. 1 is represented in FIG. 2. The differences relate to the manner in which air streams are cooled with ram air. For in the system which is shown in FIG. 2 the fresh air and the discharged air recirculated to the cabin 12 are cooled in separate ram air heat exchangers. For this purpose the distributor 96 is not connected to a mixer 38, as in FIG. 1, but to a secondary heat exchanger 100. Similarly to the heat exchanger 42, this is connected to an inlet valve 104, which has a connection with a ram air inlet 108. The heat exchanger 100 is connected on the outlet side for the ram air to an outlet valve 106, which in turn communicates with a ram air outlet 110. It may in this case be expedient to connect together the ram air inlets 92 and 104 of the heat exchangers 42 and 100 as well as the outlets 94 and 108. It is also possible, as a further alternative, for the inlets 92 and 104 and the outlets 94 and 108, respectively, to be identical.

Instead of a mixer 38 disposed between the distributor 86 and the mixer 40 as in FIG. 1, the distributor 86 for the fresh air is connected directly to the mixer 40. A part of a fresh air stream coming directly from the distributor 86 and a part of the fresh air stream routed via the cooling device 24 can be mixed together in the mixer 40—as in the system shown in FIG. 1. There is a connection from the mixer 40 to the heat exchanger 42, similarly to the system in FIG. 1. A mixer 102 is provided downstream of the heat exchanger 42, in which mixer a fresh air stream from the heat exchanger 42 can be mixed with the stream of recycled cabin air. For this purpose the mixer 102 is also connected to the secondary heat exchanger 100, via which cooled cabin air can flow. In order that the heat exchanger 100 may be bypassed, a connection between the distributor 96 and a mixing point N is provided. Here cabin air which has not been routed via the heat exchanger 100 can be fed into the line to the mixer 102. Hereby, in a variant, a mixing device can be disposed also at the mixing point N.

The heat exchanger 100 supplied with ram air serves to cool recirculated air which has been discharged from the cabin 12 before this is merged with fresh air from one or more of the pressure sources 52, 54 and 56. The fresh air and the re-used cabin air can therefore be cooled separately. The individual heat exchangers can as a result be smaller and lighter, and greater flexibility and accuracy in the control and cooling of the air streams is achieved.

As can easily be recognised by an average person skilled in the art, the air conditioning system according to the invention affords a great many possibilities of mixing fresh air with cabin air and supplying this to the aircraft cabin. This affords a high degree of flexibility in reacting to external conditions and requirements on board. The air conditioning of the aircraft cabin can at the same time be carried out in a particularly efficient and energy-saving manner by using the cabin exhaust air particularly efficiently to recover water and to recover energy. This relates in particular to the fact that bleed air can be saved, which results in a considerable fuel saving. Load can be distributed among different components, for example, different compressed-air sources, according to requirements, which reduces the total load per component. This results in a longer service life and a lower susceptibility to faults. Also, in the event of one component of the air conditioning system failing, the functionality of the total system can be easily maintained, at least in part, as the system has incorporated redundancy on account of its flexibility.

1. Air conditioning system for an aircraft cabin, comprising:
at least one air inlet for supplying air to the cabin;
at least one air outlet for discharging air from the cabin;
at least one compressed-air source, which is adapted to provide pressurised fresh air for supplying to the cabin via the at least one air inlet;
a heat exchanger supplied with ram air from a ram air inlet for cooling air from the at least one compressed-air source,
wherein the heat exchanger is disposed upstream of the air inlet of the cabin;
wherein the air conditioning system comprises a cabin air heat exchanger which is designed to be supplied with air discharged from the cabin via the at least one air outlet and intended to be supplied to the cabin again,
wherein the cabin air heat exchanger is disposed downstream of the at least one air outlet and upstream of a point at which fresh air from the at least one pressure source is mixed with air from the cabin intended to be supplied to the cabin again;
wherein a mixing device is provided downstream of the mixing point and upstream of the at least one cabin air inlet, which device is adapted to mix bleed air from a bleed air source with air flowing in via the mixing point; and
wherein a further mixing device is provided which is adapted to receive at least one air stream from the at least one compressed-air source for mixing.

2. Air conditioning system according to claim 1,
wherein the cabin air heat exchanger for cooling air discharged from the cabin is also designed to be supplied with ram air from a ram air inlet.

3. Air conditioning system according to claim 1,
wherein the heat exchanger for cooling fresh air is disposed upstream of the mixing point.

4. Air conditioning system according to claim 1,
wherein a mixing device adapted to merge a fresh air stream and a cabin air stream is provided at the mixing point.

5. Air conditioning system according to claim 1,
wherein the air conditioning system comprises, as compressed-air sources, a bleed air source, a source of compressed ram air and a source of air compressed by an auxiliary power unit.

6. Air conditioning system according to claim 1,
wherein the air conditioning system further comprises downstream of the at least one air outlet of the cabin a power recovery device for recovering energy from discharged cabin air, and
wherein a heating device, which is coupled to an external heat reservoir, for heating air discharged from the cabin is disposed downstream of the cabin.

7. Air conditioning system according to claim 6,
wherein the heating device with external heat reservoir is disposed upstream of the power recovery device.

8. Air conditioning system according to claim 6,
wherein a heat exchanger is disposed upstream of the heating device with external heat reservoir and downstream of the air outlet.

9. Air conditioning system according to claim 8,
wherein the heat exchanger is adapted to facilitate heat exchange between air discharged from the cabin and fresh air coming from one or a plurality of compressed-air source(s).

10. Air conditioning system according to claim 6,
wherein the at least one heat reservoir comprises hot machine oil.

11. Air conditioning system according to claim 6,
wherein the air conditioning system further comprises an auxiliary power unit.

12. Air conditioning system according to claim 11,
wherein the power recovery device is adapted to drive the auxiliary power unit.

13. Air conditioning system according to claim 6,
wherein the air conditioning system further comprises a motor coupled to a ram air compressor, and
wherein the power recovery device is coupled to the motor and the ram air compressor such that, in an operating mode in which the power recovery device is driven by discharged cabin air, the power recovery device is adapted to drive the motor with a generator function and the ram air compressor.

14. Air conditioning system according to claim 6, wherein the power recovery device is embodied as a turbine.

15. Air conditioning system according to claim 1,
including at least one water separator disposed downstream of the air outlet of the cabin, and
wherein the at least one water separator is provided for the through-flow of air which is intended for discharge into the ambient atmosphere of the aircraft.

16. Air conditioning system according to claim 15,
wherein the air conditioning system comprises at least one power recovery device disposed downstream of the air outlet of the cabin.

17. Air conditioning system according to claim 16,
wherein the at least one water separator is disposed downstream of the at least one power recovery device.

18. Air conditioning system according to claim 16,
wherein the at least one water separator is disposed upstream of the at least one power recovery device.

19. Air conditioning system according to claim 15,
wherein at least one water separator is disposed upstream of the cabin and at least one water separator is disposed downstream of the cabin.

20. Aircraft including an air conditioning system according to claim 1.
